(19) United States
(12) Patent Application Publication
(10) Pub. No.: US 2026/0101138 A1
(43) Pub. Date: Apr. 9, 2026

(54) DUAL COMPRESSION DRIVER WITH RECTANGULAR EXIT

(71) Applicant: Harman Professional, Inc., Northridge, CA (US)

(72) Inventors: Alexander Voishvillo, Simi Valley, CA (US); Erik Hjalmar Mjukis Lundin, Ventura, CA (US)

(73) Assignee: Harman Professional, Inc., Northridge, CA (US)

(21) Appl. No.: 18/902,090

(22) Filed: Sep. 30, 2024

(51) Int. Cl. H04R 1/30; H04R 7/06; H04R 7/18; H04R 9/06

(52) U.S. Cl. CPC H04R 1/30; H04R 7/06; H04R 7/18; H04R 9/06; H04R 2201/34

(57) ABSTRACT

A dual-compression driver with a rectangular exit, a hornlet aligned within the central axis of the dual compression driver. The hornlet has a contoured transition from a circular base at the first end to a blade shape at the second end that terminates at the rectangular exit. The dual-compression driver may include a horn having a rectangular throat is coupled to the rectangular exit of the dual-compression driver.

### TECHNICAL FIELD

The disclosure relates to electro-acoustical drivers and loudspeakers employing electro-acoustical drivers. More particularly, the disclosure relates to configurations for compression drivers.

### BACKGROUND

An electro-acoustical transducer or driver is utilized as a loudspeaker or as a component in a loudspeaker system to transform electrical signals into acoustical ones. A driver receives electrical signals and converts the electrical signals to acoustic signals. The driver typically includes mechanical, electromechanical, and magnetic elements to effect the conversion. Electro-acoustical transducers or drivers may be characterized into two broad categories: direct-radiating types and compression types. In compression types, a compression driver produces sound waves in a high-pressure enclosed volume, or compression chamber, before radiating the sound waves to the typically much lower pressure open-air environment. The compression chamber is open to a structure commonly referred to as a phasing plug that works as a connector between the compression chamber and a horn. A compression driver utilizes a compression chamber on the output side of a diaphragm to generate relatively higher-pressure sound energy prior to radiating the sound waves from the loudspeaker. The area of the entrance to the phasing plug is smaller than an area of the diaphragm. This provides increased efficiency compared to a direct-radiating loudspeaker. Compression drivers are primarily used for generating high sound-pressure levels. In a dual compression driver two compression drivers are “merged” into a single transducer with a single acoustical output and each diaphragm is loaded by its own phasing plug having radial acoustical channels.

Typically, for a compression driver, the phasing plug is interposed between the diaphragm and the waveguide or horn portion of the loudspeaker and is spaced from the diaphragm by a small distance (typically a fraction of a millimeter). Accordingly, the compression chamber is bounded on one side by the diaphragm and on the other side by the phasing plug. Reproduction and propagation of high frequency sounds may be controlled by configurations of the phasing plug, the wave guide, and an exit of the compression driver. The sound pressure signal is directed through slots in phasing plug from compression chambers, having an annular diaphragm, and then to a central rectangular exit opening. The central rectangular exit provides a narrower aperture in the horizonal plane and a wider aperture in a vertical plane. An advantage of the rectangular exit is that directivity is controlled only by the dimensions of the rectangular exit opening. The opening is smaller in the horizontal plane and wider in the vertical plane. However, for a dual compression driver, directivity is controlled in only one plane.

A dual compression driver is thus desired which provides more flexible control over directivity in both planes.

### SUMMARY

A dual-compression driver may comprise a first diaphragm with an annular aperture about a central axis. The annular aperture transitions to a rectangular exit. The dual-compression driver may also include a first phasing plug. Furthermore, the driver may include a second diaphragm, a second phasing plug, and a hornlet positioned at a central axis of the first and second phasing plugs. The hornlet has a circular first end attached to the second diaphragm, a blade-like shaped second end that extends past the rectangular exit of the first diaphragm, and a contoured transition from the circular first end to the blade-like shaped second end. Additionally, the driver may include an adapter positioned at the rectangular exit of the first diaphragm. The adapter has a rectangular aperture with a width along an x-axis horizontal to the central axis and a length along a z-axis perpendicular to the central axis.

The described implementations may also include one or more of the following features: a shape of the contoured transition of the hornlet, dimensions of the rectangular exit, and dimensions of the rectangular aperture control directivity of an acoustic signal; the contoured transition of the hornlet is convex and defines a path length in a horizontal plane of the first diaphragm that is equidistant to a path length in a vertical plane of the first diaphragm; the dimensions of the rectangular exit and the dimensions of the rectangular aperture of the adapter are equal to 127 mm in the horizontal plane and 425 mm in the vertical plane; and the dimensions of the rectangular exit and the dimensions of the rectangular inlet are equal to 127 mm in the horizontal plane and 609 mm in the vertical plane.

A hornlet may include a circular base at a first end, a blade-shaped second end, and a contoured transition from the first end to the second end.

The described implementations may also include one or more of the following features: the contoured transition of the hornlet is convex, defining a path length through the compression driver in a horizontal plane that is equidistant to a path length in a vertical plane; the compression driver is a dual-compression driver; the circular base is on a central axis, and the rectangular exit of the compression driver has a width along the x-axis and a length along the z-axis, where the x and z axes are relative to the central axis; the rectangular exit of the compression driver has a width of 127 mm and a length of 425 mm; and the rectangular exit of the compression driver has a width of 127 mm and a length of 609 mm.

A loudspeaker may include a dual-compression driver having a rectangular exit, a hornlet aligned within a central axis of the dual-compression driver, the hornlet having a contoured transition from a circular base at a first end to a blade-shape at a second end. The second end terminates at the rectangular exit, and a horn having a rectangular throat may be coupled to the rectangular exit of the dual-compression driver.

The described implementations may also include one or more of the following features: the contoured transition of the hornlet is convex, defining a path length in a horizontal plane that is equidistant to a path length in a vertical plane; the hornlet is at a central axis, and the rectangular exit of the compression driver has a width along the x-axis and a length along the z-axis; the rectangular exit of the dual-compression driver has a width of 127 mm and a length of 425 mm; and the rectangular exit of the dual-compression driver has a width of 127 mm and a length of 609 mm.

### BRIEF DESCRIPTION OF THE DRAWINGS

The disclosure may be better understood from reading the following description of non-limiting embodiments, with reference to the attached drawings, wherein below:

FIG. 1 shows a perspective view of an example of a loudspeaker in which a dual compression driver may be implemented, in accordance with one or more embodiments of the present disclosure;

FIG. 2 shows an exploded perspective view of the dual compression driver of FIG. 2, in accordance with one or more embodiments of the present disclosure;

FIG. 3A shows a cutaway horizontal view of the dual compression driver that may be provided with the loudspeaker of FIG. 1, in accordance with one or more embodiments of the present disclosure;

FIG. 3B shows a cutaway vertical view of the dual compression driver of FIG. 2, in accordance with one or more embodiments of the present disclosure;

FIG. 4A shows a cutaway horizontal view of one or more embodiments of the dual compression driver of FIG. 2;

FIG. 4B shows a cutaway vertical view of one or more embodiments of the dual compression driver of FIG. 2;

FIG. 5A is graph of normalized off-axis responses in the horizontal plane of the one or more embodiments of the dual compression driver of FIGS. 3A and 3B;

FIG. 5B is a graph of normalized off-axis responses in the vertical plane of the one or more embodiments of the dual compression driver of FIGS. 3A and 3B; and

FIG. 6 is a graph of normalized off-axis responses in the vertical plane of the one or more embodiments of the dual compression driver of FIGS. 4A and 4B.

### DETAILED DESCRIPTION

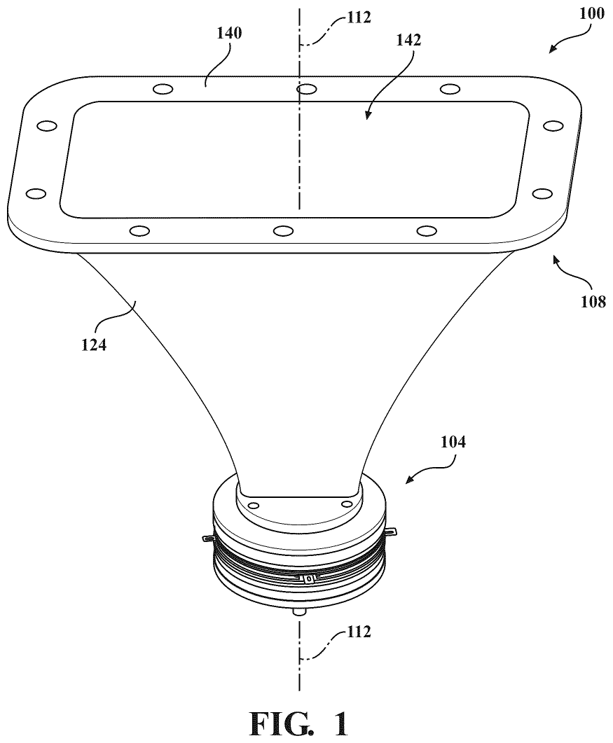

FIG. 1 illustrates a perspective view of an example of a loudspeaker 100 in which a dual compression driver 104 as described herein may be implemented. The loudspeaker 100 includes an electro-acoustical transducer section 104. In some implementations, the loudspeaker 100 may also include a horn 108. The transducer section 104 and horn 108 are generally disposed about a central axis 112. The horn 108 may include a structure 124 such as one or more walls that enclose an interior 142 of the horn 108. As illustrated, the horn structure 124 may be flared outwardly from an input end 128 at to a mouth 140 along the central axis 112. The horn 108 provides an expanding cross-sectional area through which sound waves propagate and exit at the mouth 140.

The transducer section 104 is hereinafter referred to as a dual-compression driver. Generally speaking, the loudspeaker 100 receives an input of electrical signals at an appropriate connection, such as contacts provided at the dual compression driver 104 and converts the electrical signals into acoustic signals. The acoustic signals propagate through the interior of the housing 120 and the horn 108 and exit at a mouth 140 of the horn 108.

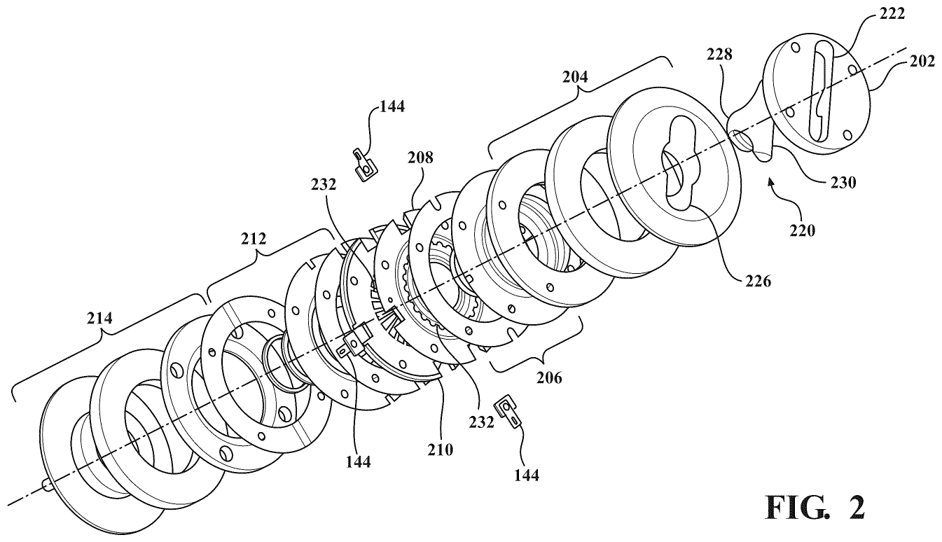

FIG. 2 is an exploded view of the dual compression driver 104. The dual compression driver 104 has an adapter 202, a first motor 204, a first diaphragm assembly 206 a first phasing plug 208, a second phasing plug 210, a second diaphragm assembly 212, a second motor 214.

The first and second diaphragm assemblies 206, 212, vibrate in a push mode when loaded by their corresponding phasing plugs 208, 210. The sound pressure signal is summed on adjacent openings in the phasing plugs and directed to a central opening and further towards an exit of the dual compression driver 104.

The dual compression driver 104 has lower displacement of both diaphragm assemblies 206, 212 as compared to a single compression driver having a similar diaphragm assembly for the same sound pressure level (SPL). The lower displacement provides lower nonlinear distortion. The electric power is split between two voice coils which decreases thermal compression and increases maximum sound pressure level.

A hornlet, hereinafter referred to as a central blade-shaped bullet, 220 is disposed in the central opening and, in one or more embodiments, attaches to the second diaphragm assembly 212. The second diaphragm assembly 212 is annular. The first diaphragm assembly 206 has an annular aperture 224 that transitions to a rectangular exit 226 that may be axially aligned along the central axis 112.

The central blade-shaped bullet 220 transforms from a circular base 228 at a first end to a linear blade-like shape 230 at a second end. The circular base 228 of the blade-shaped bullet 220 attaches to the annular aperture of the second diaphragm assembly 212. The blade-shaped bullet extends from the annular aperture of the second diaphragm assembly 212 through the annular aperture 224 of the first diaphragm assembly 206 and past the rectangular exit 226 of the first diaphragm assembly 206.

The adapter 202 accommodates attachment of the horn 108 (not shown in FIG. 2). The adapter 202 has a rectangular inlet (aperture) 222 that matches the rectangular exit 226 of the first diaphragm assembly 206.

The acoustical signal propagates from multiple radial channels 232 through meandering vertical exits 234 of the first and second phasing plugs 208, 210, towards the blade-shaped bullet 220. As the acoustical signal propagates it is organized, by the phasing plugs 208, 210, into a circumferential meandering pattern that “smears” resonances caused by an interaction of a compression chamber's air resonances and mechanical breakups of the diaphragm.

Dimensions of the rectangular inlet 222 (e.g., a length along the x-axis and a width along the z-axis, with respect to the central axis system 112) of the adapter 202 may at least partially determine control of sound wave directivity. For example, when the horn 108 is coupled to a compression driver, such as the compression driver of FIG. 2, the rectangular inlet 222 also assists in providing directivity control for high frequency sound waves generated by the compression driver.

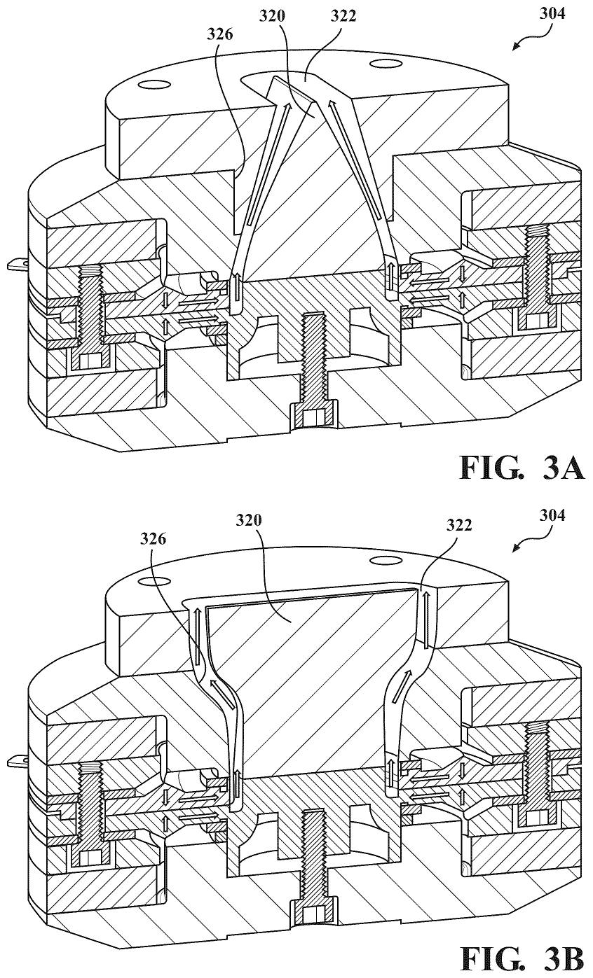

FIGS. 3A and 3B show one or more embodiments of a transducer 304 having a blade-shaped bullet 320, a rectangular exit 326 and a rectangular aperture (inlet) 322 that cooperate to establish equidistant pathlengths in the horizontal and vertical planes. FIG. 3A is a cutaway view of the transducer 304 in the horizontal plane with arrows indicating a direction of propagation of the acoustical signal. FIG. 3B is a cutaway view of the dual compression driver 304 in a vertical plane is shown. A shape of the blade-shaped bullet 320, dimensions of the rectangular exit 326, and dimensions of the rectangular inlet 322 control directivity of the acoustical signal. Arrows indicate the direction of propagation of the acoustical signal. The acoustical signal arrives with similar delay across the rectangular inlet 322 and the rectangular exit 326. In the embodiment shown in FIGS. 3A and 3B the dimension of the aperture 322 is 12.7 mm in the horizontal plane and 42.5 in the vertical plane.

When a loudspeaker, including the horn 108, coupled to the dual-compression driver 104 is oriented such that the width of the rectangular inlet 222, 322 (and respectively, a width of the rectangular exit 226, 326 of the dual-compression driver 104, 304) is positioned in a horizontal dimension (e.g., perpendicular to an amplitude of sound waves), the width may be as small as is desired to provide high frequency directivity control. The length may be as large as is desirable for an area of the rectangular inlet 222, 322 to approximately equal an area of the rectangular exit 226, 326 of the dual compression driver 104, 304.

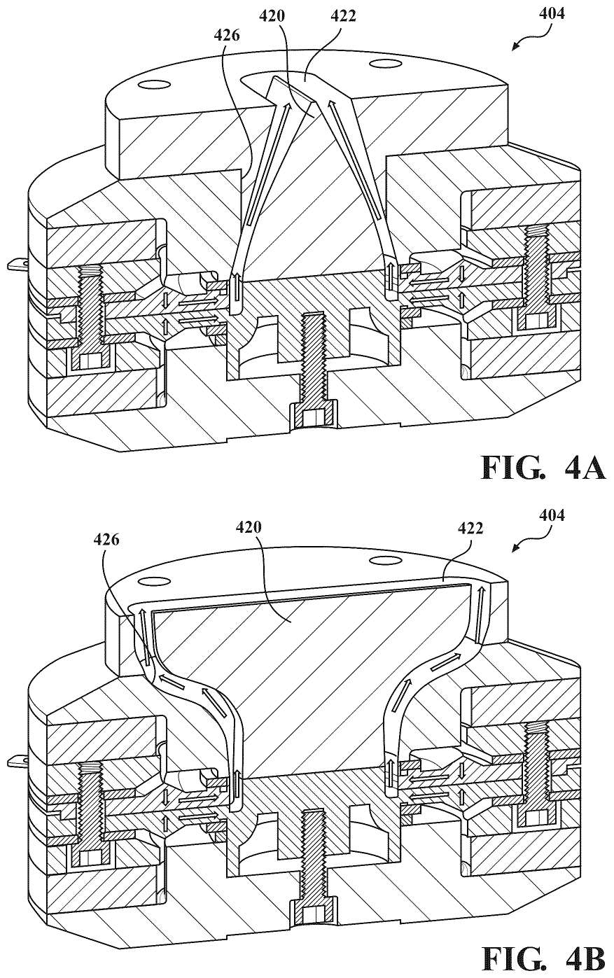

FIGS. 4A and 4B show one or more embodiments of a dual-compression driver 404 having a convex wavefront. The blade-shaped bullet 420 curves in a manner that, when working with the dimensions of the rectangular exit 426 and the rectangular inlet, creates a convex wavefront at the rectangular inlet. This configuration introduces a time delay between a center of the exit 426 and both edges of the blade-shaped bullet 420 in the vertical plane. In the example shown in FIGS. 4A and 4B the dimension of the rectangular inlet 422 is 12.7 mm in the horizontal plane and 60.9 mm in the vertical plane. The result is a time delay of 0.017 ms (equivalent to 6 mm) between the center of the exit 426 and both edges of the exit 426 in the vertical plane.

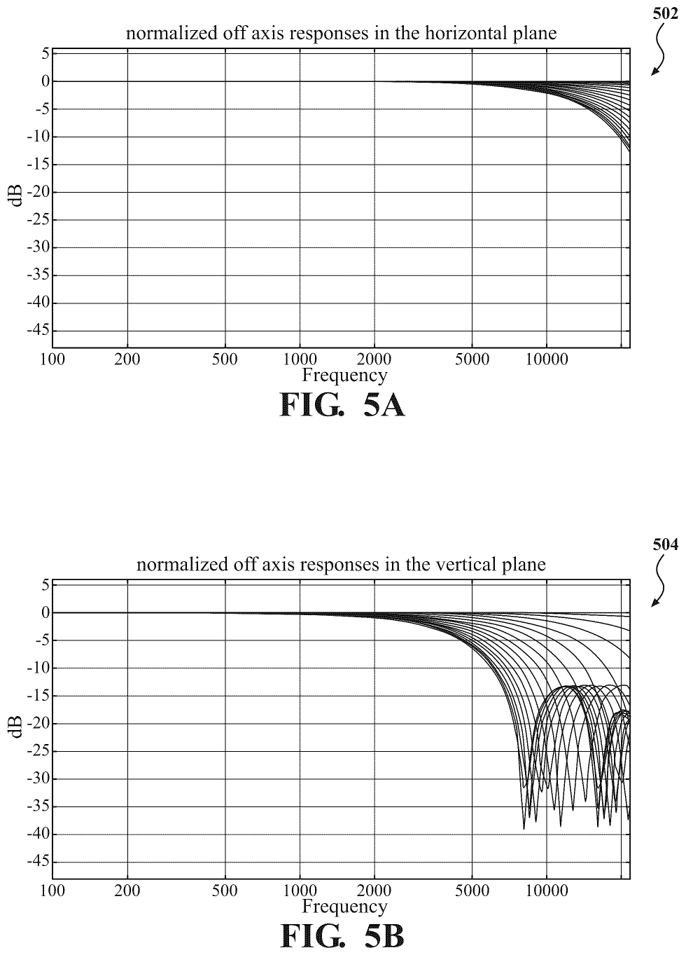

A comparison of the example shown in FIGS. 3A and 3B with the example shown in FIGS. 4A and 4B, shows directivity in the horizontal plane is similar and directivity in the vertical plane is improved. FIG. 5A is graph 502 of normalized off-axis responses in the horizontal plane of the one or more embodiments of FIGS. 3A and 3B. The graph shows that in the horizontal plane, the rectangular inlet 322 provides a narrowing of directivity. At reasonable angles, ±45 degrees, attenuation is approximately 5 decibels at 20 kHz. FIG. 5B is a graph 504 of normalized off-axis responses in the vertical plane. In the vertical plane, high-frequency attenuation is greater due to the increased dimension of the rectangular inlet 322.

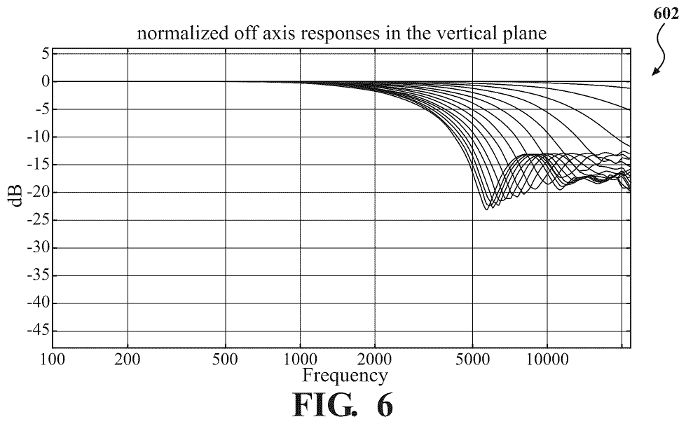

FIG. 6 is a graph 602 of normalized off-axis responses in the vertical plane of the one or more embodiments of FIGS. 4A and 4B having a convex wavefront in the vertical plane. The directivity (as compared to that shown in FIG. 5B) is improved, wherein high-frequency directivity responses become smoother and combing effect (as compared to FIG. 5B) is mitigated.

The inventive subject matter is advantageous in that the dual driver results in low moving mass of each diaphragm assembly, thereby providing higher frequency mass roll-off. High internal damping of the diaphragm assembly decreases nonlinear distortion associated with high frequency breakup modes. A configuration of the rectangular exit and the blade-shaped bullet is advantageous in that directivity in the vertical plane is improved through increasing pathlengths across the vertical dimension.

1. A dual-compression driver, comprising:
a first diaphragm having an annular aperture about a central axis, the annular aperture transitions to a rectangular exit;
a first phasing plug;
a second diaphragm;
a second phasing plug;
a hornlet positioned at a central axis of the first and second phasing plugs, the hornlet has a circular first end attached to the second diaphragm, a blade-like shaped second end that extends past the rectangular exit of the first diaphragm, and a contoured transition from the circular first end to the blade-like shaped second end; and
an adapter positioned at the rectangular exit of the first diaphragm, the adapter has a rectangular aperture having a width along an x-axis horizontal to the central axis and a length along a z-axis perpendicular to the central axis.

2. The dual-compression driver, as claimed in claim 1, wherein a shape of the contoured transition of the hornlet, dimensions of the rectangular exit, and dimensions of the rectangular aperture control directivity of an acoustic signal.

3. The dual-compression driver, as claimed in claim 1, wherein the contoured transition of the hornlet is convex and defines a pathlength in a horizontal plane of the first diaphragm that is equidistant to a pathlength in a vertical plane of the first diaphragm.

4. The dual-compression driver, as claimed in claim 3, wherein the dimensions of the rectangular exit and the dimensions of the rectangular aperture of the adapter are equal to 12.7 mm in the horizontal plane and 42.5 mm in the vertical plane.

5. The dual-compression driver, as claimed in claim 3, wherein the dimensions of the rectangular exit and the dimensions of the rectangular inlet are equal to 12.7 mm in the horizontal plane and 60.9 mm in the vertical plane.

6. A hornlet for a compression driver having a rectangular exit, the hornlet comprising:
a circular base at a first end;
a blade-shaped second end; and
a contoured transition from the first end to the second end.

7. The hornlet as claimed in claim 6, wherein the contoured transition is convex, defining a pathlength through the compression driver in a horizontal plane that is equidistant to a pathlength in a vertical plane.

8. The hornlet as claimed in claim 6, wherein the compression driver is a dual-compression driver.

9. The hornlet as claimed in claim 6, wherein the circular base is on a central axis and the rectangular exit of the compression driver has a width along the x-axis and a length along the z-axis, wherein the x and z axes are relative to the central axis.

10. The hornlet as claimed in claim 9, wherein the rectangular exit of the compression driver has a width of 12.7 mm and a length of 42.5 mm.

11. The hornlet as claimed in claim 9, wherein the rectangular exit of the compression driver has a width of 12.7 mm and a length of 60.9 mm.

12. A loudspeaker, comprising:
a dual-compression driver having a rectangular exit;
a hornlet aligned within a central axis of the dual compression driver, the hornlet having a contoured transition from a circular base at a first end to a blade-shape at a second end, the second end terminates at the rectangular exit; and
a horn having a rectangular throat coupled to the rectangular exit of the dual-compression driver.

13. The loudspeaker as claimed in claim 12, wherein the contoured transition is convex, defining a pathlength in a horizontal plane that is equidistant to a pathlength in a vertical plane.

14. The loudspeaker as claimed in claim 12, wherein the hornlet is at a central axis and the rectangular exit of the compression driver has a width along the x-axis and a length along the z-axis.

15. The loudspeaker as claimed in claim 14, wherein the rectangular exit of the dual-compression driver has a width of 12.7 mm and a length of 42.5 mm.

16. The loudspeaker as claimed in claim 14, wherein the rectangular exit of the dual-compression driver has a width of 12.7 mm and a length of 60.9 mm.
